(19) United States
(12) Patent Application Publication
(10) Pub. No.: US 2023/0260493 A1
(43) Pub. Date: Aug. 17, 2023

(54) SOUND SYNTHESIZING METHOD AND PROGRAM

(71) Applicant: YAMAHA CORPORATION, Hamamatsu-shi (JP)

(72) Inventors: Ryunosuke DAIDO, Hamamatsu-shi (JP); Keijiro SAINO, Hamamatsu-shi (JP)

(21) Appl. No.: 18/301,123

(22) Filed: Apr. 14, 2023

Related U.S. Application Data
(63) Continuation of application No. PCT/JP2021/037824, filed on Oct. 13, 2021.

(30) Foreign Application Priority Data
Oct. 15, 2020 (JP) 2020-174215
Oct. 15, 2020 (JP) 2020-174248

(51) Int. Cl. G10H 7/00; G10H 1/00; G10L 13/033; G10L 13/04; G10L 13/06

(52) U.S. Cl. CPC G10H 7/002; G10H 1/0008; G10L 13/0335; G10L 13/04; G10L 13/06; G10H 2210/066; G10H 2220/121

(57) ABSTRACT

A sound synthesizing method according to one aspect of the present disclosure relates to a sound synthesizing method that is realized by a computer, including receiving musical score data and acoustic data via a user interface; and generating, based on respective one of the musical score data and the acoustic data, acoustic features of a sound waveform having a desired timbre.

### CROSS REFERENCE TO RELATED APPLICATIONS

The present application is a continuation application of International Application No. PCT/JP2021/037824, filed Oct. 13, 2021, which claims a priority to Japanese Patent Application No. 2020-174215, and 2020-174248 filed Oct. 15, 2020. The contents of these applications are incorporated herein by reference in their entirety.

### TECHNICAL FIELD

The present disclosure relates to a speech synthesizing method and a program thereof. In the present specification, “speech” means “sound” in general and is not limited to the “human voice”.

### BACKGROUND

Known are speech synthesizers that synthesize the singing voice of a specific singer or the sound of a specific musical instrument being played. Speech synthesizers using machine learning learn, as supervised data, acoustic data with musical score data for a specific singer or musical instrument. A speech synthesizer that has learned acoustic data of a specific singer or musical instrument synthesizes, when supplied with musical score data by a user, the singing voice of the specific singer or the sound of a specific musical instrument being played, and outputs the synthesized singing voice or instrument sound. Japanese Patent Application Publication No. 2019-101094 discloses a technique for synthesizing a singing voice using machine learning. Also known is a technique for converting the voice quality of a singing voice, using a singing voice synthesizing technique.

### SUMMARY

A speech synthesizer can synthesize, when supplied with musical score data, the singing voice of a specific singer or the sound of a specific musical instrument being played. However, it is difficult for a conventional speech synthesizer to generate acoustic data of the same timbre (sound quality) based on musical score data and acoustic data supplied from a user interface, regardless of the type of data.

An object of the present disclosure is to generate acoustic data of the same timbre (sound quality) based on musical score data and acoustic data supplied from a user interface, regardless of the type of data. The object of “generating acoustic data of the same timbre (sound quality) based on musical score data and acoustic data supplied from a user interface, regardless of the type of data” may encompass an object of “generating content consistent as a whole musical piece using musical score data, and acoustic data relating to speech of a specific singer or musical instrument captured via a microphone”, and an object of “making it easy to add new acoustic data of the same timbre to acoustic data relating to speech of a specific timbre captured via a microphone, or to partially correct the acoustic data while maintaining the timbre”.

A sound synthesizing method according to one aspect of the present disclosure relates to a sound synthesizing method that is realized by a computer, including: receiving musical score data and acoustic data via a user interface; and generating, based on the musical score data and the acoustic data, acoustic features of a sound waveform having a desired timbre.

A sound synthesis program according to another aspect of the present disclosure relates to a program that causes a computer to execute a sound synthesizing method, the program causing the computer to execute: processing of receiving musical score data and acoustic data via a user interface; and processing of generating, based on the musical score data and the acoustic data, acoustic features of a sound waveform of a desired timbre.

According to the present disclosure, it is possible to generate acoustic data of the same timbre (sound quality) based on musical score data and acoustic data supplied from a user interface, regardless of the type of data.

### BRIEF DESCRIPTION OF DRAWINGS

FIG. 1 is a diagram illustrating a configuration of a sound synthesizer according to an embodiment;

FIG. 2 is a functional block diagram illustrating the sound synthesizer according to the embodiment;

FIG. 3 is a diagram illustrating data to be used by the sound synthesizer;

FIG. 4 is a flowchart illustrating a basic training method according to the embodiment;

FIG. 5 is a flowchart illustrating a sound synthesizing method according to the embodiment;

FIG. 6 is a diagram illustrating a user interface of the sound synthesizer;

FIG. 7 is a diagram illustrating the user interface of the sound synthesizer;

FIG. 8 is a flowchart illustrating an acoustic decoder training method according to the embodiment;

FIG. 9 is a diagram illustrating the user interface of the sound synthesizer;

FIG. 10 is a diagram illustrating the user interface of the sound synthesizer;

FIG. 11 is a diagram illustrating the user interface of the sound synthesizer; and

FIG. 12 is a flowchart illustrating a timbre conversion method according to the embodiment.

### DETAILED DESCRIPTION OF THE EMBODYMENTS

### (1) Configuration of Sound Synthesizer

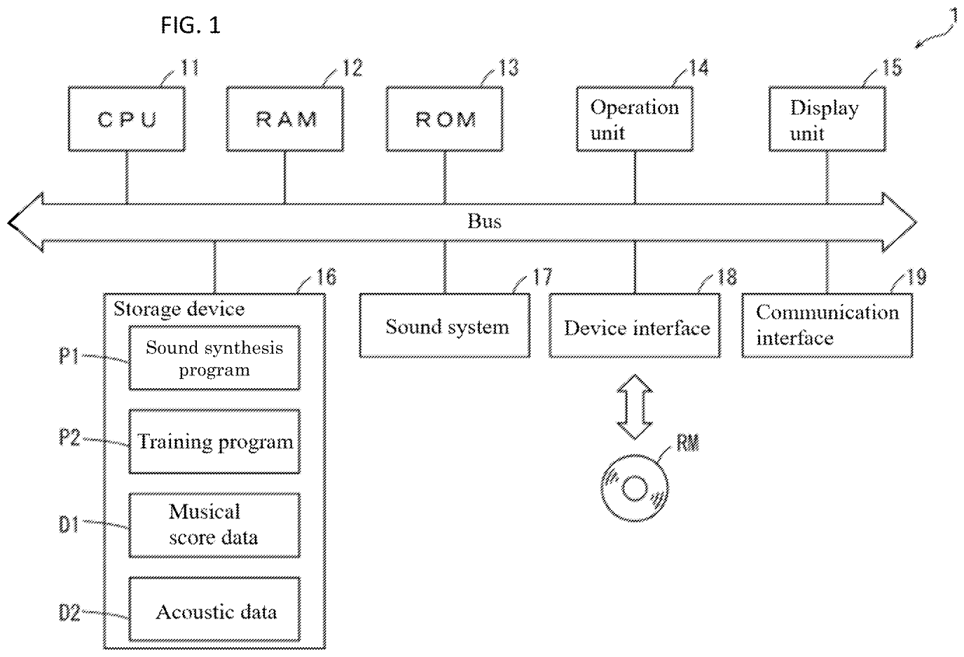

Hereinafter, a sound synthesizer according to an embodiment of the present disclosure will be described in detail with reference to the drawings. FIG. 1 is a diagram showing a configuration of a sound synthesizer 1 according to the embodiment. As shown in FIG. 1, the sound synthesizer 1 includes 25 a CPU (Central Processing Unit) 11, a RAM (Random Access Memory) 12, a ROM (Read Only Memory) 13, an operation unit 14, a display unit 15, a storage device 16, a sound system 17, a device interface 18, and a communication interface 19. For example, a personal computer, a tablet terminal, a smartphone, or the like is used as the sound synthesizer 1.

The CPU 11 is constituted by at least one processor, and performs overall control of the sound synthesizer 1. The CPU 11, which is a central processing unit, may be or may include at least one of a CPU, an MPU, a GPU, an ASIC, a FPGA, a DSP, and a general-purpose computer. The RAM 12 is used as a work area when the CPU 11 executes a program. The ROM 13 stores a control program and the like. The operation unit 14 inputs a user operation to the sound synthesizer 1. The operation unit 14 is, for example, a mouse, a keyboard, or the like. The display unit 15 displays a user interface of the sound synthesizer 1. The operation unit 14 and the display unit 15 may be configured together as a touch panel display. The sound system 17 includes a sound source, functions for D/A converting and amplifying a sound signal, a speaker for outputting an analog-converted sound signal, and the like. The device interface 18 is an interface for the CPU 11 to access a storage medium RM such as a CD-ROM or a semiconductor memory. The communication interface 19 is an interface for the CPU 11 to connect to a network such as the Internet.

The storage device 16 has stored therein a sound synthesis program P1, a training program P2, musical score data D1, and acoustic data D2. The sound synthesis program P1 is a program for generating acoustic data obtained by synthesizing sound or acoustic data obtained by converting timbre. The training program P2 is a program for training an encoder and an acoustic decoder that are used for sound synthesis or timbre conversion. The training program P2 may include a program for training a pitch model.

The musical score data D1 is data for defining a musical piece. The musical score data D1 includes information relating to the pitch and intensity of notes, information relating to the phonemes within notes (only in cases of singing), information relating to sound generation period of notes, information relating to musical symbols, and the like. The musical score data D1 is, for example, data indicating at least one of the notes and words of a musical piece, and may be data indicating a series of notes indicating melody of the musical piece, or data indicating a series of words indicating lyrics of the musical piece. The musical score data D1 may also be, for example, data indicating timings on a time axis or pitches on a pitch axis for notes indicating the melody of the musical piece and words indicating the lyrics of the musical piece. The acoustic data D2 is waveform data of a sound. The acoustic data D2 is, for example, waveform data of a vocal piece, waveform data of an instrumental piece, or the like. In other words, the acoustic data D2 is waveform data of “the singing voice of a singer or the playing sound of a musical instrument” captured via, for example, a microphone. In the sound synthesizer 1, the musical score data D1 and the acoustic data D2 are used to generate content of a single musical piece.

### (2) Functional Configuration of Sound Synthesizer

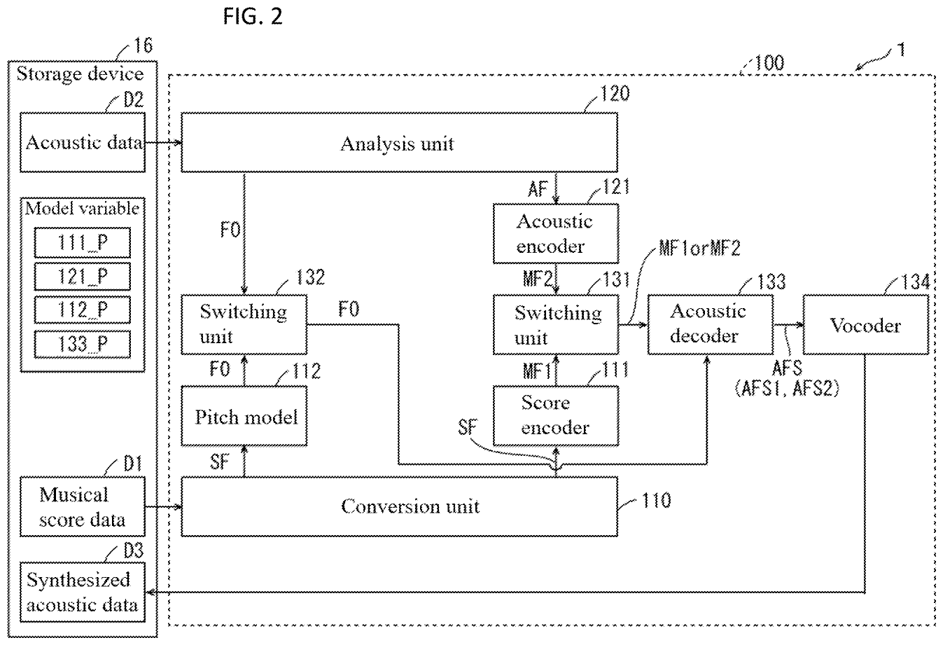

FIG. 2 is a functional block diagram of the sound synthesizer 1. As shown in FIG. 2, the sound synthesizer 1 includes a control unit 100. The control unit 100 includes a conversion unit 110, a score encoder 111, a pitch model 112, an analysis unit 120, an acoustic encoder 121, a switching unit 131, a switching unit 132, an acoustic decoder 133, and a vocoder 134. In FIG. 2, the control unit 100 is a functional unit realized by the CPU 11 executing the sound synthesis program P1 using the RAM 12 as a work area. In other words, the conversion unit 110, the score encoder 111, the pitch model 112, the analysis unit 120, the acoustic encoder 121, the switching unit 131, the switching unit 132, the acoustic decoder 133, and the vocoder 134 are functional units realized by the CPU 11 executing the sound synthesis program P1. Also, the score encoder 111, the acoustic encoder 121, and the acoustic decoder 133 learn their functions by the CPU 11 executing the training program P2 using the RAM 12 as a work area. Also, the pitch model 112 may learn its function by the CPU 11 executing the training program P2 using the RAM 12 as a work area.

The conversion unit 110 reads the musical score data D1 to create various types of score feature data SF based on the musical score data Dl. The conversion unit 110 outputs the read score feature data SF to the score encoder 111 and the pitch model 112. The score feature data SF that is obtained by the score encoder 111 from the conversion unit 110 is a factor for controlling a timbre at each time point, and is a context such as pitch, intensity, or phoneme label, for example. The score feature data SF that is obtained by the pitch model 112 from the conversion unit 110 is a factor for controlling a pitch at each time point, and is a note context specified by pitch and sound generation period, for example. The context includes, in addition to data at each time point, data relating to at least one of the previous and next time point. The time resolution is, for example, 5 milliseconds.

The score encoder 111 generates, based on the score feature data SF at each time point, intermediate feature data MF1 at the time point. The well-trained score encoder 111 is a statistical model for generating the intermediate feature data MF1 from the score feature data SF, and is defined by a plurality of variables 111_P stored in the storage device 16. In the present embodiment, a generation model for outputting intermediate feature data MF1 that corresponds to the score feature data SF is used as the score encoder 111. For example, a convolution neural network (CNN), a recurrent neural network (RNN), a combination thereof, or the like is used as the generation model that configures the score encoder 111. An autoregressive model or a model with attention mechanism may also be used as the generation model. The intermediate feature data MF1 generated from the score feature data SF of the musical score data D1 by the well-trained score encoder 111 is referred to as “intermediate feature data MF1 corresponding to the musical score data D1”.

The pitch model 112 reads the score feature data SF and generates, based on the score feature data SF at each time point, a fundamental frequency F0 of the sound of a musical piece at the time point. The pitch model 112 outputs the obtained fundamental frequency F0 to the switching unit 132. The well-trained pitch model 112 is a statistical model for generating the fundamental frequency F0 of the sound of a musical piece from the score feature data SF, and is defined by a plurality of variables 112_P stored in the storage device 16. In the present embodiment, a generation model for outputting the fundamental frequency F0 that corresponds to the score feature data SF is used as the pitch model 112. For example, a CNN, a RNN, a combination thereof, or the like is used as the generation model that configures the pitch model 112. An autoregressive model or a model with attention mechanism may also be used as the generation model. In contrast, a much simpler hidden Markov model or random forest model may also be used.

The analysis unit 120 reads the acoustic data D2 to perform frequency analysis on the acoustic data D2 at each time point. By performing frequency analysis on the acoustic data D2 using a predetermined frame (having, e.g., a width of 40 milliseconds and a shift amount of 5 milliseconds), the analysis unit 120 generates the fundamental frequency F0 and acoustic feature data AF of the sound indicated by the acoustic data D2. The acoustic feature data AF indicates a frequency spectrum, at each time point, of the sound indicated by the acoustic data D2, and is a mel-scale log-spectrum (MSLS), for example. The analysis unit 120 outputs the fundamental frequency F0 to the switching unit 132. The analysis unit 120 outputs the score feature data AF to the acoustic encoder 121.

The acoustic encoder 121 generates, based on the acoustic feature data AF at each time point, intermediate feature data MF2 at the time point. The well-trained acoustic encoder 121 is a statistical model for generating the intermediate feature data MF2 from the acoustic feature data AF, and is defined by a plurality of variables 121_P stored in the storage device 16. In the present embodiment, a generation model for outputting the intermediate feature data MF2 that corresponds to the acoustic feature data AF is used as the acoustic encoder 121. For example, a CNN, an RNN, a combination thereof or the like is used as the generation model that configures the acoustic encoder 121. The intermediate feature data MF2 generated by the well-trained acoustic encoder 121 based on the acoustic feature data AF of the acoustic data D2 is referred to as “intermediate feature data MF2 corresponding to the acoustic data D2”.

The switching unit 131 receives the intermediate feature data MF1 at each time point from the score encoder 111. The switching unit 131 receives the intermediate feature data MF2 at each time point from the acoustic encoder 121. The switching unit 131 selectively outputs, to the acoustic decoder 133, one of the intermediate feature data MF1 from the score encoder 111 and the intermediate feature data MF2 from the acoustic encoder 121.

The switching unit 132 receives the fundamental frequency F0 at each time point from the pitch model 112. The switching unit 132 receives the fundamental frequency F0 at each time point from the analysis unit 120. The switching unit 132 selectively outputs, to the acoustic decoder 133, one of the fundamental frequency F0 from the pitch model 112 and the fundamental frequency F0 from the analysis unit 120.

The acoustic decoder 133 generates, based on the intermediate feature data MF1 or the intermediate feature data MF2 at each time point, acoustic feature data AFS at the time point. The acoustic feature data AFS is data representing a frequency amplitude spectrum, and is a mel-scale log-spectrum, for example. The well-trained acoustic decoder 133 is a statistical model for generating the acoustic feature data AFS from at least one of the intermediate feature data MF1 and the intermediate feature data MF2, and is defined by a plurality of variables 133_P stored in the storage device 16. In the present embodiment, a generation model for outputting the acoustic feature data AFS that corresponds to the intermediate feature data MF1 or the intermediate feature data MF2 is used as the acoustic decoder 133. For example, a CNN, a RNN, a combination thereof or the like is used as the model that configures the acoustic decoder 133. An autoregressive model or a model with attention mechanism may also be used as the generation model.

The vocoder 134 generates synthesized acoustic data D3 based on the acoustic feature data AFS at each time point supplied from the acoustic decoder 133. If the acoustic feature data AFS is a mel-scale log-spectrum, the vocoder 134 converts the mel-scale log-spectrum at each time point that was input from the acoustic encoder 121 into acoustic signals in a time domain, and sequentially couples the acoustic signals to each other along a time axis direction, thereby generating the synthesized acoustic data D3.

### (3) Information used by Sound Synthesizer

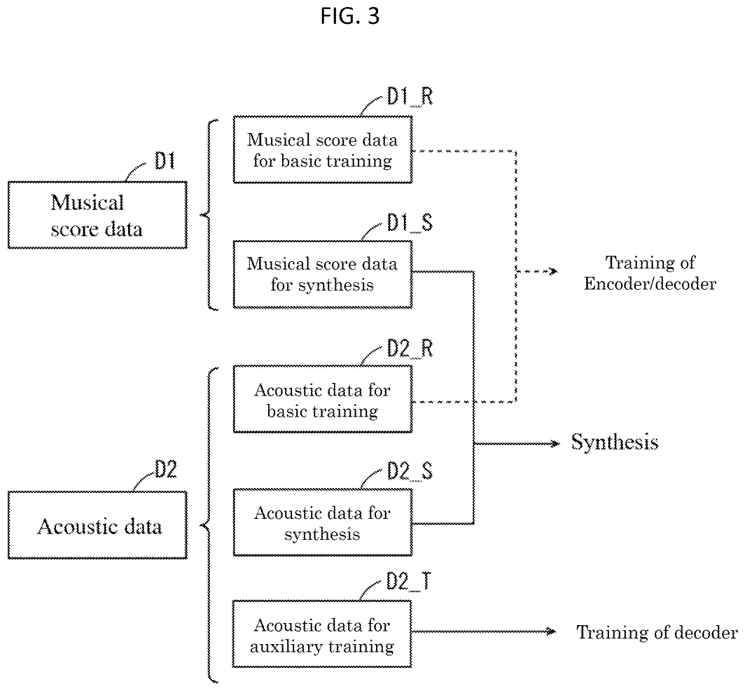

FIG. 3 shows data to be used by the sound synthesizer 1. The sound synthesizer 1 uses the musical score data D1 and the acoustic data D2 as data relating to sound synthesis. As described above, the musical score data D1 is data for defining a musical piece. The musical score data D1 includes information relating to, e.g., the pitch and intensity of notes, information relating to phonemes within notes (only in cases of singing), information relating to sound generation period of notes, information relating to performance symbols, and the like. As described above, the acoustic data D2 is sound waveform data. The acoustic data D2 is, for example, singing waveform data, instrumental sound waveform data, or the like. Each piece of singing waveform data is added with a sound source ID (timbre identifier) indicating a singer who has performed the singing, and each piece of instrumental sound waveform data is added with a sound source ID indicating the musical instrument. The sound source ID indicates a source (sound source) from which the sound indicated by this waveform data was generated.

The musical score data D1 used by the sound synthesizer 1 includes musical score data D1_R for basic training and musical score data D1_S for synthesis. The acoustic data D2 used by the sound synthesizer 1 includes acoustic data D2_R for basic training, acoustic data D2_S for synthesis, and acoustic data D2_T for auxiliary training. The musical score data D1_R for basic training corresponding to the acoustic data D2_R for basic training indicates a score (such as a musical note sequence) corresponding to a musical performance of the acoustic data D2_R for basic training. The musical score data D1_S for synthesis corresponding to the acoustic data D2_S for synthesis indicates a score (such as a musical note sequence) corresponding to a musical performance of the acoustic data D2_S for synthesis. The musical score data D1 “corresponding” to the acoustic data D2 means that, for example, notes (and phonemes) of a musical piece defined by the musical score data D1, and notes (and phonemes) of a musical piece denoted by the waveform data indicated by the acoustic data D2 are identical to each other in their performance timing, performance intensity, performance expression, and the like. Although, in FIGS. 1 and 2, the musical score data D1 and the acoustic data D2 are shown in the storage device 16, the musical score data D1_R for basic training and the musical score data D1_S for synthesis are actually stored as the musical score data D1, and the acoustic data D2_R for basic training, the acoustic data D2_S for synthesis, and the acoustic data D2_T for auxiliary training are actually stored as the acoustic data D2.

The musical score data D1_R for basic training is data for use in training the score encoder 111, the acoustic encoder 121, and the acoustic decoder 133. The musical score data D2_R for basic training is data for use in training the score encoder 111, the acoustic encoder 121, and the acoustic decoder 133. As a result of training the score encoder 111, the acoustic encoder 121, and the acoustic decoder 133 using the musical score data D1_R for basic training and the acoustic data D2_R for basic training, the sound synthesizer 1 is established to be able to synthesize sound of the timbre (sound source) specified by a sound source ID.

The musical score data D1_S for synthesis may be supplied to the sound synthesizer 1 established to be able to synthesize the sound of a specific timbre (sound source). The sound synthesizer 1 generates the synthesized acoustic data D3 of the sound of the timbre specified by a sound source ID, based on the musical score data D1_S for synthesis. For example, in cases of singing synthesis, when supplied with words (phonemes) and a melody (a series of musical notes), the sound synthesizer 1 can synthesize the singing voice of a singer x specified by a sound source ID (x), which is one of the singing voices of a plurality of singers specified by a plurality of sound source IDs, and output the synthesized voice. In cases of instrumental sound synthesis, when the sound source ID (x) is designated and a melody (a series of musical notes) is supplied, the sound synthesizer 1 can synthesize the sound of a musical instrument x specified by the sound source ID (x) being played, and output the synthesized sound. The sound synthesizer 1 is trained using: (A) a plurality of pieces of acoustic data D2_R for basic training representing the sound generated by a sound source A (that is, a singer A or a musical instrument A) specified by a specific sound source ID(A); and (B) a plurality of pieces of musical score data D1_R for basic training that respectively correspond to the plurality of acoustic data D2_R for basic training. Such training may also be referred to as “basic training according to the sound source A”. When the ID(A) and the musical score data D1_S for synthesis are supplied to the well-trained sound synthesizer 1 (subjected to the “basic training according to the sound source A”), the sound synthesizer 1 synthesizes the sound (voice or sound) of the sound source A. In other words, the sound synthesizer 1 subjected to the basic training according to the sound source A synthesizes, upon designation of a sound source ID(A), the singing voice of the singer A having the ID(A) singing or the sound of the musical instrument A having the ID(A) playing the musical piece defined by the musical score data D1_S for synthesis. The sound synthesizer 1 subjected to the basic training according to a plurality of sound sources x (singers x or musical instruments x) synthesizes, upon designation of an ID(x1) of a sound source x1, the sound (voice or sound) of the sound source x1 singing or playing the musical piece defined by the synthesis musical score data D1 S.

The acoustic data D2_S for synthesis may be supplied to the sound synthesizer 1 established to be able to synthesize sound of a specific timbre. The sound synthesizer 1 generates, based on the acoustic data D2_S for synthesis, the synthesized acoustic data D3 of the sound of the timbre specified by a designated sound source ID. For example, when the sound synthesizer lis supplied with a sound source ID and the acoustic data D2_S for synthesis and the acoustic data D2_S is of a singer or musical instrument having a certain sound source ID other than the sound source of the designated sound source ID, the sound synthesizer 1 synthesizes and output the singing voice of the singer specified by this sound source ID or the sound of the musical instrument specified by this sound source ID. By this operation, the sound synthesizer 1 functions as a type of timbre conversion unit. Upon being supplied with the ID(A) and the musical score data D2_S for synthesis representing the sound generated by a sound source B different from the sound source A, the sound synthesizer 1 subjected to training (specifically, “basic training according to the sound source A”) synthesizes the sound (voice or sound) of the sound source A based on the acoustic data D2_S. In other words, the sound synthesizer 1 supplied with the Id(A) synthesizes the singing voice of the singer A singing or the sound of the musical instrument A played the musical piece defined by the synthesis acoustic data D2_S. That is to say, the sound synthesizer 1 supplied with the Id(A) synthesizes, from the sound “that was obtained by a musical piece being sung by a singer B or played on a musical instrument 10 B” and captured via a microphone, the sound “that is obtained by the musical piece being sung by a singer A having the Id(A) or played on a musical instrument A having the Id(A)”.

The acoustic data D2_T for auxiliary training is for use in training (auxiliary training or additional training) the acoustic decoder 133. The acoustic data D2_T for auxiliary training is for changing timbre of a sound which can be synthesized by the acoustic decoder 133. As a result of training the acoustic decoder 133 using the acoustic data D2_T for auxiliary training, the sound synthesizer 1 is established to be able to synthesize the singing voice of another new singer. For example, the acoustic decoder 133 of the sound synthesizer 1 that has been subjected to the basic training according to the sound source A is further trained using the acoustic data D2_T for auxiliary training, which indicates sound generated by a sound source C with an Id(C) other than the sound source A used in the basic training. Such training may also be referred to as “auxiliary training according to the sound source C”. Basic training refers to elemental training performed by the manufacturer of the sound synthesizer 1, and is performed using an enormous amount of training data so that changes in pitch, intensity, and timbre in play of an unseen musical piece with respect to various sound sources can be covered. In contrast, auxiliary training refers to training performed in an auxiliary manner by a user who uses the sound synthesizer 1 to adjust sound to be generated, and the amount of training data for use in this training may be much smaller than that of the basic training. However, for this, it is necessary for the sound source A in basic training to include at least one sound source somewhat similar to the sound source C in the timbre tendency. Upon being input with the ID (C) and supplied with the musical score data D1_S for synthesis, the sound synthesizer 1 subjected to the “auxiliary training according to the sound source C” synthesizes the sound (voice or sound) of the sound source C based on the musical score data D1 S. In other words, the sound synthesizer 1 supplied with the ID(C) synthesizes the singing voice of the singer C singing or the sound of the musical instrument C played the musical piece defined by the musical score data D1_S for synthesis. Besides, when the ID(C) is designated and the acoustic data D2_S for synthesis representing the sound generated by a sound source B, which is different from the sound source C, is supplied, the sound synthesizer 1 subjected to the “auxiliary training according to the sound source C” synthesizes the sound (voice or sound) of the sound source C based on the acoustic data D2_S. In other words, the sound synthesizer 1 supplied with the ID(C) synthesizes the singing voice of the singer C singing or the sound of the musical instrument C played the musical piece defined by the waveform indicated by the acoustic data D2_S for synthesis. That is to say, the sound synthesizer 1 supplied with the ID(C) synthesizes, from the sound “that was obtained by a musical piece being sung by a singer B or played on a musical instrument B” and captured via a microphone, the sound “that is obtained by the musical piece being sung by a singer C having the ID(C) or played on a musical instrument C having the ID(C)”.

### (4) Basic Training Method

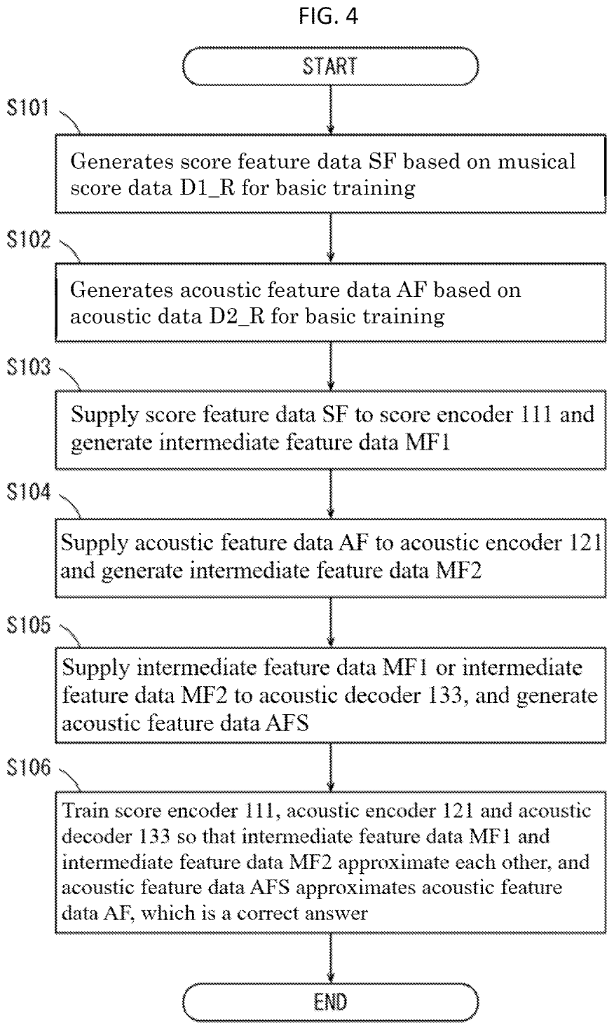

The following will describe a basic training method that is performed by the sound synthesizer 1 according to the present embodiment. FIG. 4 is a flowchart illustrating a basic training method that is performed by the sound synthesizer 1 according to the present embodiment. In the basic training, the score encoder 111, the acoustic encoder 121, and the acoustic decoder 133 of the sound synthesizer 1 are trained. The basic training method shown in FIG. 4 is realized by the CPU 11 executing the training program P2 in each of processing steps of machine learning. In the first processing step, acoustic data that corresponds to a plurality of frequency analysis frames is processed.

Before executing the basic training method in FIG. 4, for each sound source ID, a plurality of sets of musical score data D1_R for basic training and corresponding acoustic data D2_R for basic training are prepared as supervised data, and are stored in the storage device 16. The musical score data D1_R for basic training and the acoustic data D2_R for basic training that are prepared as supervised data are data prepared for use in basic training of each sound synthesizer 1 with respect to the timbre specified by each sound source ID. The following will describe, as an example, a case where the musical score data D1_R for basic training and the acoustic data D2_R for basic training are data prepared for basic training with respect to the singing voices of a plurality of singers specified by a plurality of sound source IDs.

In step S101, the CPU 11 that functions as the conversion unit 110 generates score feature data SF at each time point based on the musical score data D1_R for basic training. In the present embodiment, for example, data indicating a phoneme label is used as the score feature data SF indicating features of a musical score for generating acoustic features. Then, in step S102, the CPU 11 that functions as the analysis unit 120 generates acoustic feature data AF representing a frequency spectrum at each time point, based on the acoustic data D2_R for basic training, for which the timbre is specified by a sound source ID. In the present embodiment, for example, a mel-scale log-spectrum is used as the acoustic feature data AF. Note that the processing in step S102 may be executed before the processing in step S101.

Then, in step S103, the CPU 11 uses the score encoder 111 to process the score feature data SF at each time point and generate intermediate feature data MF1 at the time point. Then, in step S104, the CPU 11 uses the acoustic encoder 121 to process the acoustic feature data AF at each time point and generate intermediate feature data MF2 at the time point. Note that the processing in step S104 may be executed before the processing in step S103.

Then, in step S105, the CPU 11 uses the acoustic decoder 133 to process the sound source ID of the acoustic data D2_R for basic training, and the fundamental frequency F0 and the intermediate feature data MF1 at each time point, and generate acoustic feature data AFS1 at the time point. The CPU 11 also processes this sound source ID, and the fundamental frequency F0 and the intermediate feature data MF2 at each time point, and generates acoustic feature data AFS2 at the time point. In the present embodiment, for example, a mel-scale log-spectrum is used as the acoustic feature data AFS representing a frequency spectrum at each time point. Note that the acoustic decoder 133 is supplied with the fundamental frequency F0 from the switching unit 132 during the execution of acoustic decoding. If input data is the musical score data D1_R for basic training, the fundamental frequency F0 is generated by the pitch model 112, and if input data is the acoustic data D2_R for basic training, the fundamental frequency F0 is generated by the analysis unit 120. Also, the acoustic decoder 133 is supplied with the sound source ID serving as an identifier for identifying a singer during the execution of acoustic decoding. The fundamental frequency F0 and the sound source ID, together with the intermediate feature data MF1 and MF2, are used as values to be input to a generation model constituting the acoustic decoder 133.

Then, in step S106, the CPU 11 trains the score encoder 111, the acoustic encoder 121 and the acoustic decoder 133 so that, with respect to each piece of acoustic data D2_R for basic training, the intermediate feature data MF1 and the intermediate feature data MF2 approximate each other, and the acoustic feature data AFS approximates the acoustic feature data AF, which is a correct answer. That is to say, the intermediate feature data MF1 is generated from the score feature data SF (indicating e.g., a phoneme label) and the intermediate feature data MF2 is generated from the frequency spectrum (e.g., a mel-scale log-spectrum), and the generation model for the score encoder 111 and the generation model for the acoustic encoder 121 are trained so that the distances of the two pieces of intermediate feature data MF1 and MF2 approximate each other.

Specifically, back propagation of a difference between the intermediate feature data MF1 and the intermediate feature data MF2 is executed so as to reduce the difference, and the variables 111_P of the score encoder 111 and the variables 121 P of the acoustic encoder 121 are updated. As the difference between the intermediate feature data MF1 and the intermediate feature data MF2, for example, a Euclidean distance of vectors indicating the two types of data is used. In parallel, back propagation of an error is executed so that the acoustic feature data AFS generated from the acoustic decoder 133 approximates the acoustic feature data AF generated from the acoustic data D2_R for basic training, which is supervised data, and the variables 111_P of the score encoder 111, the variables 121_P of the acoustic encoder 121, and the variables 133_P of the acoustic decoder 133 are updated. The score encoder 111 (variables 111_P), the acoustic encoder 121 (variables 121_P), and the acoustic decoder 133 (variables 133_P) may be trained simultaneously or separately. A configuration is also possible in which, for example, the well-trained score encoder 111 (variables 111_P) or the acoustic encoder 121 (variables 121_P) is unchanged, and only the acoustic decoder 133 (variables 133_P) is trained. Also, in stop S106, training of the pitch model 112, which is a machine learning model (generation model), may be executed. In other words, the pitch model 112 is trained so that the fundamental frequency F0 to be output by the pitch model 112 to which the score feature data SF was input, and the fundamental frequency F0 generated by the analysis unit 120 through frequency analysis on the acoustic data D2 are close to each other.

By repeatedly executing training processing in the series of processing steps (from steps S101 to S106) with respect to the musical score data D1_R for basic training and the acoustic data D2_R for basic training, which are a plurality of pieces of supervised data, the score encoder 111, the acoustic encoder 121 and the acoustic decoder 133 are trained so that acoustic data (corresponding to the singing voice of a singer or the sound of a musical instrument being played) of a specific timbre (sound source) specified by each sound source ID and whose timbre at each time point varies according to score features SF can be synthesized. Specifically, the well-trained sound synthesizer 1 can use the score encoder 111 and the acoustic decoder 133 based on the musical score data D1 to synthesize the sound (singing voice or instrumental sound) of the well-trained specific timbre (sound source). Also, the well-trained sound synthesizer 1 can use the acoustic encoder 121 and the acoustic decoder 133 based on the acoustic data D2 to synthesize the sound (singing voice or instrumental sound) of the well-trained specific timbre (sound source).

As described above, in the basic training of the acoustic decoder 133, the sound source IDs of the acoustic data D2_R for basic training are used as input values. Accordingly, the acoustic decoder 133 uses the acoustic data D2_R for basic training, of a plurality of sound source IDs in the training, so as to perform training while distinguishing the singing voices of a plurality of singers and the sounds made by a plurality of musical instruments.

### (5) Sound Synthesizing Method

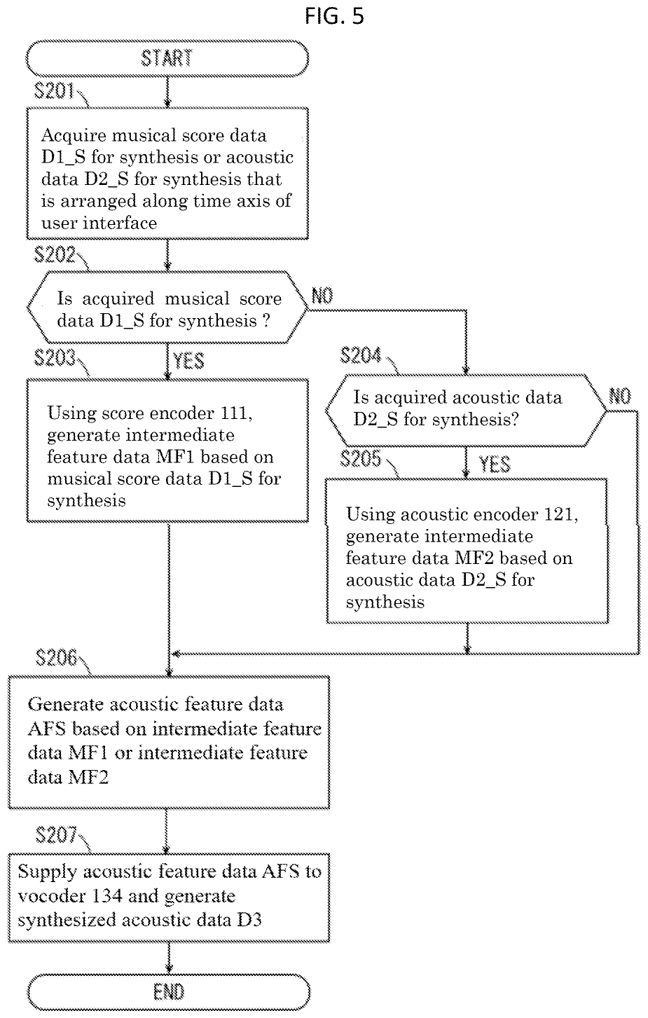

The following will describe a method for synthesizing the sound of the timbre of a designated sound source ID using the sound synthesizer 1 according to the present embodiment. FIG. 5 is a flowchart showing a sound synthesizing method performed by the sound synthesizer 1 according to the present embodiment. The sound synthesizing method shown in FIG. 5 is realized by the CPU 11 executing the sound synthesis program P1 at each time (time point) that corresponds to a frequency analysis frame. For ease of description, it is here assumed that generation of the fundamental frequency F0 from the musical score data D1_S for synthesis and generation of the fundamental frequency F0 from the acoustic data D2_S for synthesis have been completed in advance. Note that the generation of the basic frequencies F0 may be executed in parallel to the processing in FIG. 5.

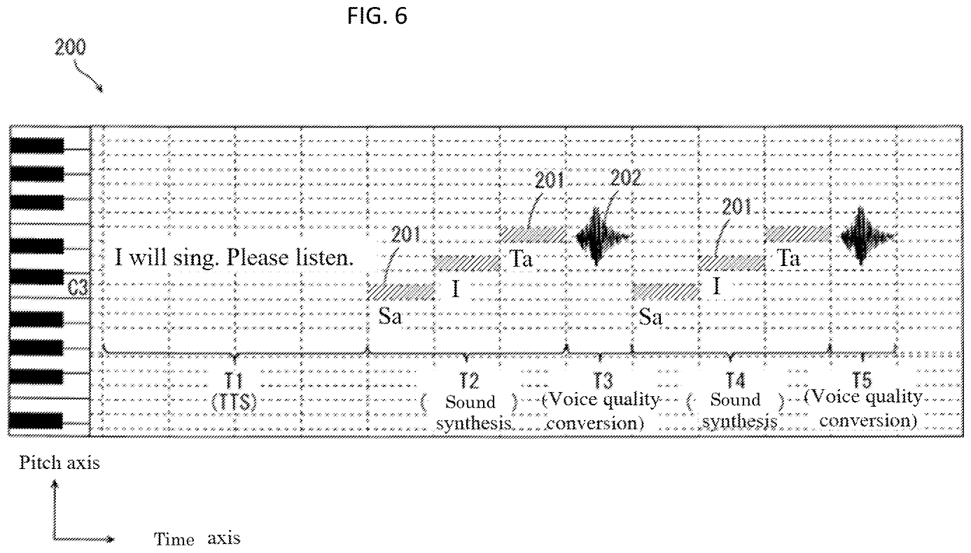

In step S201, the CPU 11 that functions as the conversion unit 110 acquires the musical score data D1_S for synthesis that is arranged before or after the time (each time point) of the frequency analysis frame along the time axis of the user interface. Alternatively, the analysis unit 120 acquires the acoustic data D2_S for synthesis that is arranged before or after the time (each time point) of this frame along the time axis of the user interface. FIG. 6 is a diagram showing a user interface 200 to be displayed on the display unit 15 by the sound synthesis program Pl. In the present embodiment, as the user interface 200, for example, a piano roll having a time axis and a pitch axis is used. As shown in FIG. 6, a user operates the operation unit 14 to arrange the musical score data D1_S (notes or text) for synthesis and the acoustic data D2_S (waveform data) for synthesis at positions of the piano roll that correspond to desired time and pitches. In time periods T1, T2 and T4 in the drawing, the musical score data D1_S for synthesis is arranged on the piano roll by the user. In the time period T1, only text without pitches (talk in the musical piece) is arranged by the user (TTS function). In the time periods T2 and T4, a temporal sequence of notes (pitch and sound generation period) and words to be sung with the notes are arranged by the user (singing voice synthesizing function). In the drawing, a block 201 indicates the pitch and the sound generation period of the notes. Also, below the block 201, the words (phonemes) to be sung with the notes are shown. Also, in the time periods T3 and T5, the acoustic data D2_S for synthesis is arranged by the user at a desired time position on the piano roll (timbre conversion function). In the drawing, a waveform 202 is a waveform indicated by the acoustic data D2_S (waveform data) for synthesis, and is located at any position in the pitch axis direction. Alternatively, the waveform 202 may be automatically arranged at a position that corresponds to the fundamental frequency F0 of the acoustic data D2_S for synthesis. Also, in the drawing, not only the notes but also the words are arranged in cases of singing synthesis, but in cases of instrumental sound synthesis, none of words nor text need to be arranged.

Then, in step S202, the CPU 11 that functions as the control unit 100 determines whether or not data acquired at the current time (each time point) is the musical score data D1_S for synthesis. If the acquired data is the musical score data D1_S (notes) for synthesis, the procedure advances to step S203. In step S203, the CPU 11 generates score feature data SF at the time point from the musical score data D1_S for synthesis, and uses the score encoder 111 to process the score feature data SF and generate intermediate feature data MF1 at the time point. The score feature data SF indicates, for example, features of phonemes in cases of singing synthesis, and the timbre of singing to be generated is controlled based on the phonemes. Also, in cases of instrumental sound synthesis, the score feature data SF indicates the pitch and intensity of the notes, and the timbre of instrumental sound to be generated is controlled based on the pitch and intensity.

Then, in step S204, the CPU 11 that functions as the control unit 100 determines whether or not data acquired at the current time (each time point) is the acoustic data D2_S for synthesis. If the acquired data is the acoustic data D2_S (waveform data) for synthesis, the procedure advances to step S205. In step S205, the CPU 11 generates acoustic features AF (frequency spectrum) at the time point from the acoustic data D2_S for synthesis, and uses the acoustic encoder 121 to process the acoustic features AF and generate intermediate feature data MF2.

After the execution of step S203 or step S205, the procedure advances to step S206. In step S206, the CPU 11 uses the acoustic decoder 133 to process the sound source ID designated at each time point, the fundamental frequency F0 at the time point, and the intermediate feature data MF1 or the intermediate feature data MF2 generated at the time point, and generate an acoustic feature data AFS at the time point. Because training is performed so that two types of intermediate feature data generated in the basic training approximate each other, the intermediate feature data MF2 generated from the acoustic feature data AF, same as the intermediate feature data MF1 generated from the score feature data, reflects the features of the corresponding notes. In the present embodiment, the acoustic decoder 133 couples the intermediate feature data MF1 and the intermediate feature data MF2 that are sequentially generated along the time axis, and then executes decoding processing on the coupled intermediate feature data, thereby generating acoustic feature data AFS.

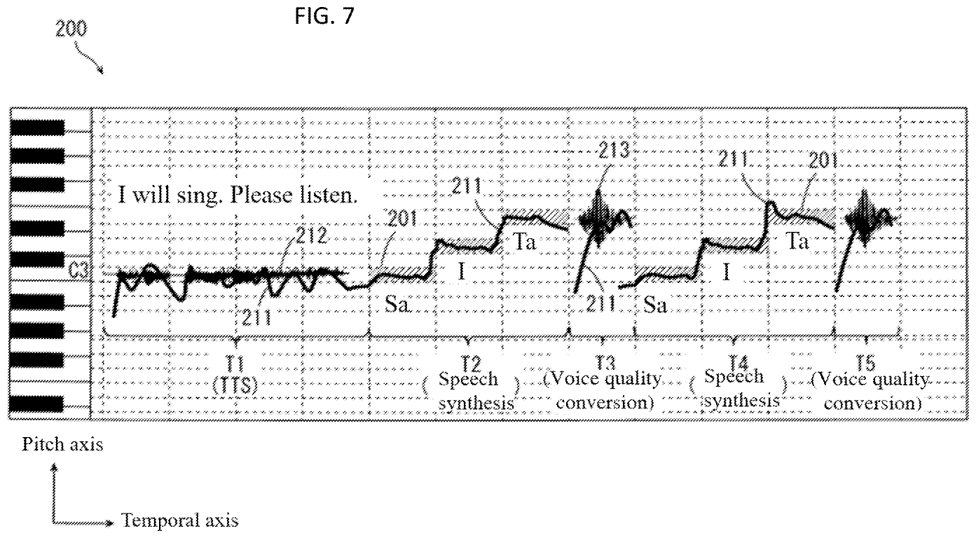

Then, in step S207, the CPU 11 that functions as the vocoder 134 generates, based on the acoustic feature data AFS representing the frequency spectrum at each time point, synthesized acoustic data D3, which is waveform data basically having the timbre indicated by the sound source ID, the timbre varying according to the phonemes and the pitches. Since the intermediate feature data MF1 and the intermediate feature data MF2, which are temporally adjacent to each other, are coupled to each other along the time axis to generate the acoustic feature data AFS, content of the synthesized acoustic data D3 in which connections in the musical piece are natural is generated. FIG. 7 is a diagram showing the user interface 200 that indicates sound synthesizing processing results. In FIG. 7, a generated fundamental frequency (F0) 211 is indicated over the entire time periods T1 to T5. In the time period T1, a waveform 212 of the synthesized acoustic data D3 is superimposed on the fundamental frequency. In the time periods T3 and T5, a waveform 213 of the synthesized acoustic data D3 is superimposed on the fundamental frequency.

### (6) Acoustic Decoder Training Method

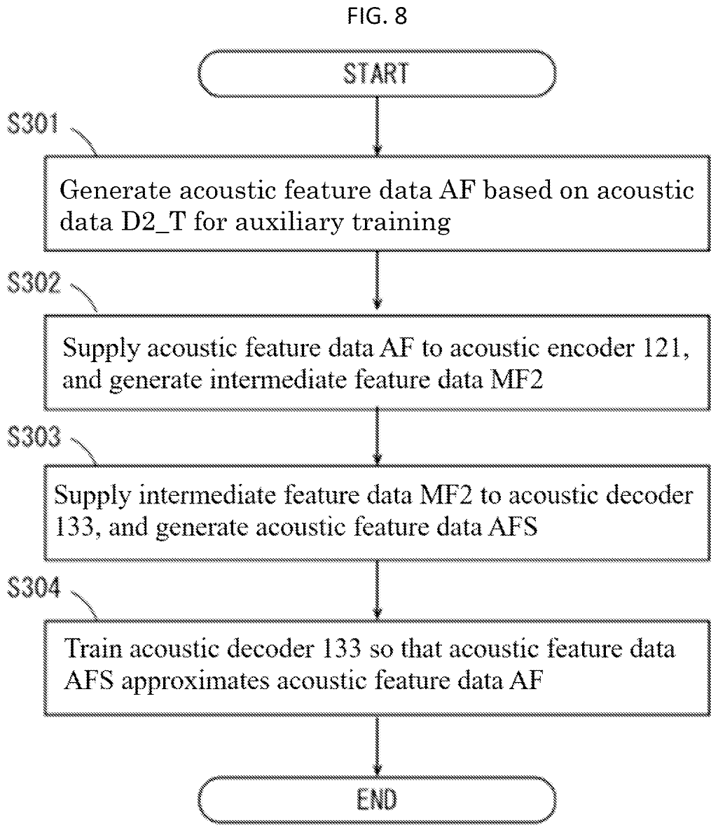

FIG. 8 is a flowchart showing an auxiliary training method that is performed on the sound synthesizer 1 according to the present embodiment. In auxiliary training, the acoustic decoder 133 of the sound synthesizer 1 is trained. In the auxiliary training method shown in FIG. 8 is realized by the training program P2 being executed. Before the auxiliary training method shown in FIG. 8 is executed, acoustic data D2_T for auxiliary training of a new timbre (sound source) specified by a new sound source ID is prepared as supervised data, and is stored in the storage device 16. The acoustic data D2_T for auxiliary training that is prepared as supervised data is data that is prepared to change the timbre (sound source) of synthesizable sound of the acoustic decoder 133 subjected to the basic training. The acoustic data D2_T for auxiliary training is typically acoustic data D2 that is different from the acoustic data D2_R for basic training used in the basic training. Because the auxiliary training is training according to a sound source different from the sound source of basic training, the sound source ID added to the acoustic data D2_T for auxiliary training is different from the sound source ID of the acoustic data D2_R for basic training. However, it is possible to perform auxiliary training with respect to the sound source of basic training, and in this case, the sound source ID of the acoustic data D2_T for auxiliary training may be the same as the sound source ID of the acoustic data D2_R for basic training. That is to say, the acoustic data D2 of the same singer or musical instrument as that of the acoustic data D2_R for basic training is used for the auxiliary training. Accordingly, it is possible for the acoustic decoder 133 to both learn the timbre of a new singer or musical instrument, and improve the timbre of an already learned singer or musical instrument. The sound qualities (timbres) of pieces of acoustic data D2 having the same sound source ID slightly may differ from each other. For example, the sound qualities (timbres) indicated by the waveform data of a piece of acoustic data D2_R for basic training and a piece of acoustic data D2_T for auxiliary training that have the same sound source ID may slightly differ from each other. The timbre indicated by the waveform data of the acoustic data D2_T for auxiliary training, having a sound source ID may be a timbre obtained by improving the timbre indicated by the waveform data of the acoustic data D2_R for basic training, having this sound source ID.

First, in step S301, the CPU 11 that functions as the analysis unit 120 generates, based on the acoustic data D2_T for auxiliary training, the fundamental frequency F0 and the acoustic feature data AF at each time point. In the present embodiment, for example, a mel-scale log-spectrum is used as the acoustic feature data AF representing the frequency spectrum of the acoustic data D2_T for auxiliary training. In the training of the acoustic decoder, only using the acoustic data D2_T for auxiliary training, the generation model (acoustic decoder 133) is caused to learn a timbre (e.g., the singing voice of a new singer) other than the timbre (sound source) of the acoustic data D2_R for basic training that was used in the basic training. Accordingly, in the training of the acoustic decoder, the musical score data D1 is not needed. That is to say, the CPU 11 trains the acoustic decoder 133 using the acoustic data D2_T for auxiliary training, without any phoneme label.

Then, in step S302, the CPU 11 uses the acoustic encoder 121 (subjected to the basic training) to process the acoustic feature data AF at each time point and generate intermediate feature data MF2 at the time point. Subsequently, in step S303, the CPU 11 uses the acoustic decoder 133 to process the sound source ID of the acoustic data D2_T for auxiliary training, and the fundamental frequency F0 and the intermediate feature data MF2 at each time point, and generate acoustic feature data AFS of the time point. Then, in step S304, the CPU 11 trains the acoustic decoder 133 so that the acoustic feature data AFS approximates the acoustic feature data AF generated from the acoustic data D2_T for auxiliary training. That is to say, the score encoder 111 and the acoustic encoder 121 are not trained, and only the acoustic decoder 133 is trained. In this way, according to the auxiliary training method of the present embodiment, the acoustic data D2_T for auxiliary training, without any phoneme label can be used in the training, and thus it is possible to train the acoustic decoder 133 without labor and cost for preparing supervised data. As described above, in the basic training, the sound synthesizer 1 is trained using, with respect to a plurality of sound sources x, a plurality of pieces of acoustic data D2_R for basic training, and a plurality of pieces of musical score data D1_R for basic training, corresponding to the respective pieces of acoustic data D2_R for basic training. In contrast, in the auxiliary training, the sound synthesizer 1 is trained only using acoustic data D2_T for auxiliary training, having a sound source y other than the plurality of sound sources x of the acoustic data D2_R for basic training, used in the basic training, or having the same sound source x. That is to say, in the auxiliary training for the sound synthesizer 1, only the acoustic data D2 is used but the musical score data D1 that corresponds to the acoustic data D2_T is not used.

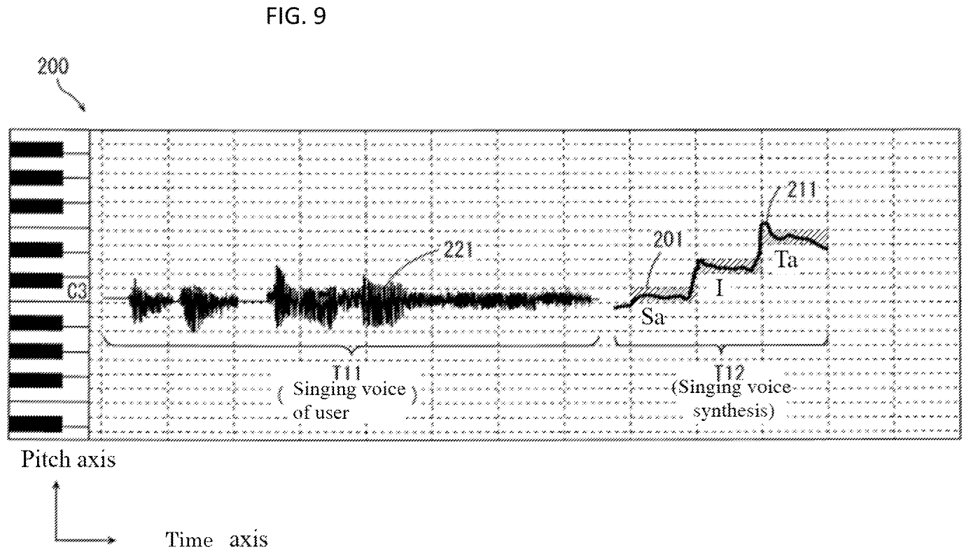

FIG. 9 is a diagram showing the user interface 200 according to the acoustic decoder training method. In response to a recording instruction made by a user, the CPU 11 newly records, for example, the singing voice of a singer or the sound of a musical instrument for one musical piece (one track), and adds a sound source ID thereto. If the sound source is a learned sound source (subjected to the basic training), the same sound source ID as the sound source ID of the acoustic data D2_R for basic training, used in the basic training is added, and if the sound source is an unlearned sound source, a new sound source ID is added. The recorded waveform data for one track is the acoustic data D2_T for auxiliary training. The recording may also be executed while the accompaniment track is being reproduced. In FIG. 9, a waveform 221 is a waveform indicated by the acoustic data D2_T for auxiliary training. After the auxiliary training for the acoustic decoder 133, the sound sung by a user or the sound of a musical instrument may be directly captured via a microphone connected to the sound synthesizer 1, and may be subjected to real-time timbre conversion processing. As a result of the CPU 11 performing the auxiliary training processing shown in FIG. 8 using the acoustic data D2_T for auxiliary training, the acoustic decoder 133 can learn the characteristics of the new singing voice or the new instrumental sound for one musical piece, and can synthesize the singing voice or instrumental sound of this voice quality. FIG. 9 further shows an aspect in which, according to a note arranging instruction from the user, the CPU 11 has arranged three notes (musical score data D1_S for synthesis) in the time period T12 along the time axis of the recorded waveform data. In the drawing, the words of the notes are input for singing synthesis, but no word is needed for instrumental sound synthesis. The CPU 11 uses the sound synthesizer 1 subjected to the auxiliary training to process, with respect to the time period T12, the musical score data D1_S for synthesis, and synthesize sound of the timbre indicated by the sound source ID of the acoustic data D2_T for auxiliary training. The CPU 11 generates, in the time period T12, content of the synthesized acoustic data D3 subjected to sound synthesis with the timbre indicated by the sound source ID, and generates, in a section (time period) T11, content of the acoustic data D2_T for auxiliary training. Alternatively, the CPU 11 may generate, in the time period T12, content of the synthesized acoustic data D3 subjected to sound synthesis with the timbre indicated by the sound source ID, and may generate, in the section T11, content of the synthesized acoustic data D3 of the timbre of the sound source ID that has synthesized by the sound synthesizer 1 upon input of the acoustic data D2_T for auxiliary training.

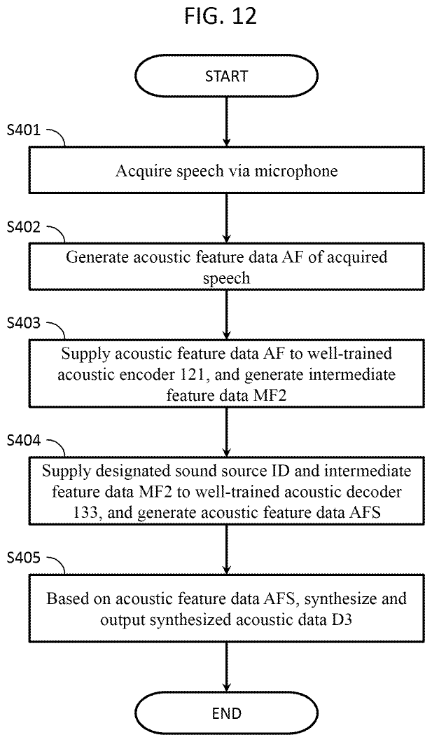

The following will describe a timbre conversion method that is performed by the sound synthesizer 1 of the present disclosure to convert input sound into the timbre having a designated sound source ID. The timbre conversion method uses the acoustic encoder 121 trained in the basic training shown in FIG. 4, and the acoustic decoder 133 trained in the basic training shown in FIG. 4 or the acoustic decoder 133 trained in the basic training and the auxiliary training shown in FIG. 8. As the sound source ID, the sound source ID of a desired singer or musical instrument, out of the sound sources ID of a plurality of sound sources subjected to the basic training or the auxiliary training, is designated by the user. FIG. 12 is a flowchart showing the timbre conversion method according to the present embodiment that is executed by the CPU 11 at each time (time point) corresponding to a frequency analysis frame.

The CPU 11 acquires the acoustic data D2 of sound at each time point that was input via a microphone (S401). The CPU 11 generates, from the acquired acoustic data D2 of sound at the time point, the acoustic feature data AF representing the frequency spectrum of the sound at the time point (S402). The CPU 11 supplies the acoustic feature data AF at the time point to the well-trained acoustic encoder 121, and generates intermediate feature data MF2 at the time point that corresponds to the sound (S403).

The CPU 11 supplies the designated sound source ID and the intermediate feature data MF2 at the time point to the well-trained acoustic decoder 133, and generates acoustic feature data AFS at the time point (S404). The well-trained acoustic decoder 133 generates, from the designated sound source ID and the intermediate feature data MF2 at the time point, acoustic feature data AFS at the time point.

The CPU 11 that functions as the vocoder 134 generates, from the acoustic feature data AFS at the time point, synthesized acoustic data D3 that indicates acoustic signals of the sound of the sound source indicated by the designated sound source ID, and outputs the generated synthesized acoustic data D3 (S405).

### (7) Example in Which Sound Captured via Microphone is Inserted into Sound Synthesized Based on Musical Score Data

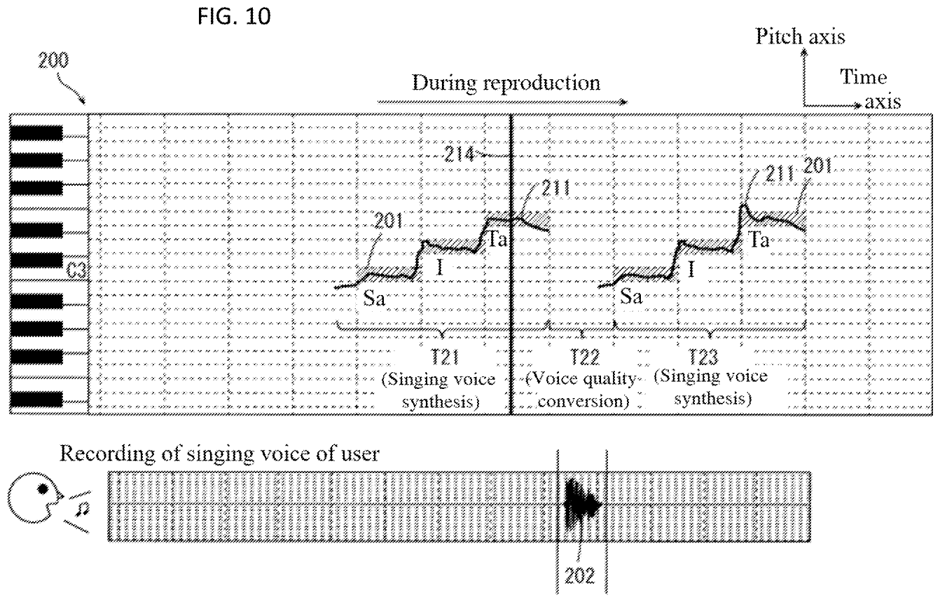

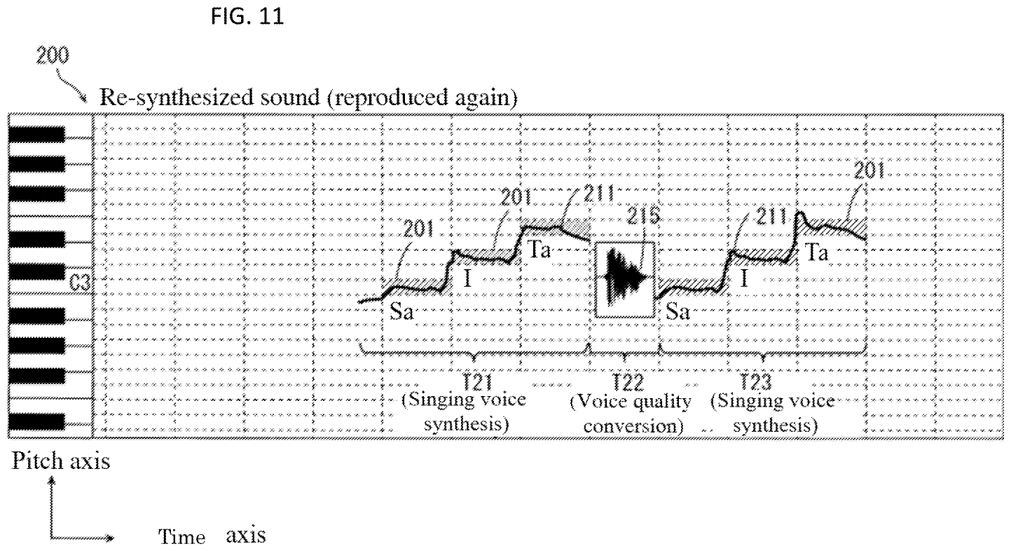

By using the sound synthesizer 1 of the embodiment, it is also possible to insert the singing voice of a user or the sound of a musical instrument into a musical piece sound-synthesized based on the musical score data D1_S for synthesis. FIG. 10 shows the user interface 200 of the sound synthesizer 1 that is used for reproducing a sound-synthesized musical piece. In time periods T21 and T23, the musical score data D1_S for synthesis is arranged by the user, and singing with the timbre indicated by the sound source ID designated by the user is synthesized by the CPU 11. When the user interface 200 shown in FIG. 10 is displayed and the user gives an instruction to start overdubbing thereon, the CPU 11 executes the sound synthesis program P1, so that the acoustic data D3 synthesized with the timbre indicated by the sound source ID is reproduced. At this time, in the user interface 200, the current time position is indicated by a time bar 214. The user sings while viewing the position of the time bar 214. The sound sung by the user is collected via a microphone connected to the sound synthesizer 1, and is recorded as the acoustic data D2_S for synthesis. In the drawing, the waveform 202 shows the waveform of the acoustic data D2_S for synthesis. The CPU 11 uses the acoustic encoder 121 and the acoustic decoder 133 to process the acoustic data D2_S for synthesis, and generate the synthesized acoustic data D3 of the timbre indicated by the sound source ID. FIG. 11 shows the user interface 200 when the waveform 215 of the synthesized acoustic data D3 is coupled to the previous or next musical score data D1_S for synthesis. At this time, the CPU 11 generates, in the time periods T21 and T23, content of the synthesized acoustic data D3 of the timbre indicated by the sound source ID singing-synthesized based on the musical score data D1_S for synthesis, and generates, in the time period T22, content of the synthesized acoustic data D3 of the timbre indicated by the sound source ID singing-synthesized based on singing of the user.

The embodiment has described, as an example, a case where the sound synthesizer 1 synthesizes the singing voice of a singer designated by the sound source ID. The sound synthesizer 1 of the present embodiment is also applicable to usages of, in addition to synthesizing the singing voice of a specific singer, synthesizing sound of various sound qualities. For example, the sound synthesizer 1 is applicable to a usage of synthesizing the sound of a musical instrument specified by a sound source ID being played.

In the embodiment, the intermediate feature data MF1 generated based on the musical score data D1_S for synthesis and the intermediate feature data MF2 generated based on the acoustic data D2_S for synthesis are coupled to each other along the time axis, and the overall acoustic feature data AFS is generated based on the coupled pieces of intermediate feature data, and the overall synthesized acoustic data D3 is generated based on this acoustic feature data AFS. As another embodiment regarding coupling along the time axis, the acoustic feature data AFS generated based on the intermediate feature data MF1, and the acoustic feature data AFS generated based on the intermediate feature data MF2 may be coupled to each other, and the overall synthesized acoustic data D3 may be generated based on this coupled pieces of acoustic feature data AFS. Alternatively, as yet another embodiment, the synthesized acoustic data D3 may be generated from the acoustic feature data AFS generated based on the intermediate feature data MF1, the synthesized acoustic data D3 may be generated from the acoustic feature data AFS generated based on the intermediate feature data MF2, and the two types of synthesized acoustic data D3 may be coupled to each other to generate the overall synthesized acoustic data D3. In any case, the coupling along the time axis may be realized by crossfading from previous data to next data, instead of switching from previous data to next data as shown with respect to the switching unit 131.

The sound synthesizer 1 of the present embodiment can synthesize the singing voice of a singer designated by a sound source ID using the acoustic data D2_S for synthesis, without any phoneme label. With this, it is possible to use the sound synthesizer 1 as a cross language synthesizer. That is to say, even if the acoustic decoder 133 is trained, with respect to this sound source ID, only with Japanese acoustic data but is trained, with respect to another sound source ID, with English acoustic data, the acoustic decoder 133 can generate singing in English language with the timbre of this sound source ID, upon input of the acoustic data D2_S for synthesis, of English words.

The embodiment has described, as an example, a case where the sound synthesis program P1 and the training program P2 are stored in the storage device 16. The sound synthesis program P1 and the training program P2 may be provided in a mode of being stored in a computer-readable storage medium RM, and may be installed in the storage device 16 or the ROM 13. Also, if the sound synthesizer 1 is connected to a network via the communication interface 19, the sound synthesis program P1 or the training program P2 distributed from a server connected to the network may be installed in the storage device 16 or the ROM 13. Alternatively, a configuration is also possible in which the CPU 11 accesses a storage medium RMF via the device interface 18, and executes the sound synthesis program P1 or the training program P2 stored in the storage medium RM.

### (8) Effects of Embodiment

As described above, the sound synthesizing method according to the present embodiment relates to a sound synthesizing method that is realized by a computer, including: receiving the musical score data (musical score data D1_S for synthesis) and the acoustic data (acoustic data D2_S for synthesis) via the user interface 200; and generating, based on the musical score data (musical score data D1_S for synthesis) and the acoustic data (acoustic data D2_S for synthesis), acoustic features (acoustic feature data AFS) of a sound waveform having a desired timbre. With this, it is possible to generate, based on the musical score data (musical score data D1_S for synthesis) and the acoustic data (acoustic data D2_S for synthesis) supplied from the user interface 200, acoustic data of the same timbre (sound quality), regardless of the type of data.

The musical score data (musical score data D1_S for synthesis) and the acoustic data (acoustic data D2_S for synthesis) may be data arranged along a time axis, and the method may include: processing the musical score data (musical score data D1_S for synthesis) using the score encoder 111 to generate first intermediate features (intermediate feature data MF1); processing the acoustic data (acoustic data D2_S for synthesis) using the acoustic encoder 121 to generate the second intermediate features (intermediate feature data MF2); and processing the first intermediate features (intermediate feature data MF1) and the second intermediate features (intermediate feature data MF2) using the acoustic decoder 133 to generate the acoustic features (acoustic feature data AFS). With this, it is possible to generate synthesized sound consistent as a whole musical piece even upon input of different aspects. That is to say, the first intermediate features generated based on the musical score data and the second intermediate features generated based on the acoustic data are both input to the acoustic decoder 133, and the acoustic decoder 133 generates, based on the input, acoustic features of the synthesized acoustic data D3. Accordingly, the sound synthesizing method according to the present embodiment can generate, based on the musical score data and the acoustic data, synthesized sound (sound indicated by the synthesized acoustic data D3) consistent as a whole musical piece.

The score encoder 111 may be trained to generate the first intermediate features (intermediate feature data MF1) from score features (score feature data SF) of training musical score data (musical score data D1_R for basic training), and the acoustic encoder 121 may be trained to generate the second intermediate features (intermediate feature data MF2) from acoustic features (acoustic feature data AF) of training acoustic data (acoustic data D2_R for basic training), and the acoustic decoder 133 may be trained to generate acoustic features close to training acoustic features (acoustic feature data AFS1 or acoustic feature data AFS2), based on the first intermediate features (intermediate feature data MF1) generated from the score features (score feature data SF) of the training musical score data (musical score data D1_R for basic training) or the second intermediate features (intermediate feature data MF2) generated from the acoustic features (acoustic feature data AF) of the training acoustic data (acoustic data D2_R for basic training). With this, it is easy to add, to acoustic data of sound of a specific timbre captured via a microphone, new acoustic data of the same timbre, or partially correct the acoustic data while maintaining the timbre.

The training musical score data (musical score data D1 R for basic training) and the training acoustic data (acoustic data D2_R for basic training) may have the same performance timing, performance intensity, and performance expression of individual notes, and the score encoder 111, the acoustic encoder 121, and the acoustic decoder 133 may be subjected to basic training so that the first intermediate features (intermediate feature data MF1) and the second intermediate features (intermediate feature data MF2) approximate each other. With this, it is possible to generate synthesized sound consistent as a whole musical piece even upon input of different aspects. That is to say, the first intermediate features generated based on the musical score data and the second intermediate features generated based on the acoustic data are both input to the acoustic decoder 133, and the acoustic decoder 133 generates, based on the input, acoustic features of the synthesized acoustic data D3. Accordingly, the sound synthesizing method according to the present embodiment can generate, based on the musical score data and the acoustic data, synthesized sound (sound indicated by the synthesized acoustic data D3) consistent as a whole musical piece.

The score encoder 111 may generate the first intermediate features (intermediate feature data MF1) from the musical score data (musical score data D1_S for synthesis) in a first time period of musical sounds, the acoustic encoder 121 may generate the second intermediate features (intermediate feature data MF2) from the acoustic data (acoustic data D2_S for synthesis) in a second time period of the musical sounds, and the acoustic decoder 133 may generate the acoustic features (acoustic feature data AFS) in the first time period from the first intermediate features (intermediate feature data MF1), and may generate the acoustic features (acoustic feature data AFS) in the second time period from the second intermediate features (intermediate feature data MF2). It is possible to generate synthesized sound consistent as a whole musical piece, even in the case of receiving input of different aspects in different time periods in a musical piece.

The score encoder 111, the acoustic encoder 121, and the acoustic decoder 133 may be machine learning models trained using training data (the musical score data D1_R for basic training or the acoustic data D2_R for basic training). By preparing supervised data of a specific timbre, it is possible to configure the score encoder 111, the acoustic encoder 121, and the acoustic decoder 133, using machine learning.

The musical score data (musical score data D1_S for synthesis) and the acoustic data (acoustic data D2_S for synthesis) may be arranged, by a user, on the user interface 200 having a time axis and a pitch axis. The user can use the sensuously simple user interface 200 to arrange the musical score data and the acoustic data over a musical piece.

The acoustic decoder 133 may generate the acoustic features (acoustic feature data AFS) based on an identifier (sound source ID) that designates a sound source (timbre). This makes it possible to generate synthesized sound of a timbre that corresponds to an identifier.

The acoustic features (acoustic feature data AFS) generated by the acoustic decoder 133 may be converted into synthesized acoustic data D3. By reproducing the synthesized acoustic data D3, it is possible to output the synthesized sound.

The first intermediate features (intermediate feature data MF1) and the second intermediate features (intermediate feature data MF2) may be coupled to each other along a time axis, and the coupled intermediate features are input to the acoustic decoder 133. This makes it possible to generate synthesized sound in which the intermediate features are coupled to each other in a naturally connected manner.

The acoustic features (acoustic feature data AFS) in the first time period and the acoustic features (acoustic feature data AFS) in the second time period may be coupled to each other, and the synthesized acoustic data D3 may be generated from the coupled acoustic features (acoustic feature data AFS). This makes it possible to generate synthesized sound in which the acoustic features are coupled to each other in a naturally connected manner.

The synthesized acoustic data D3 generated from the acoustic features (acoustic feature data AFS) in the first time period and the synthesized acoustic data D3 generated from the acoustic features (acoustic feature data AFS) in the second time period may be coupled to each other along a time axis. It is possible to generate the synthesized acoustic data D3 in which synthesized sound generated based on the musical score data D1 and synthesized sound generated based on the acoustic data D2 are coupled to each other. Various types of acoustic feature data AFS according to training and sound generation may be a spectrum such as a short-time Fourier transform or an MFCC, other than a mel-scale log-spectrum.

The acoustic data may be auxiliary training acoustic data (acoustic data D2_T for auxiliary training), and the method may include subjecting the acoustic decoder 133 to auxiliary training using the second intermediate features (intermediate feature data MF2) generated by the acoustic encoder 121 from acoustic features of the auxiliary training acoustic data (acoustic data D2_T for auxiliary training), and the acoustic features of the auxiliary training acoustic data (acoustic data D2_T for auxiliary training), so as to generate acoustic features that approximate the acoustic features of the auxiliary training acoustic data (acoustic data D2_T for auxiliary training). The musical score data D1 may be data arranged along a time axis of the auxiliary training acoustic data (acoustic data D2_T for auxiliary training), and the method may include processing, using the acoustic decoder 133 subjected to the auxiliary training, the first intermediate features (intermediate feature data MF1) generated by the score encoder 111 from the arranged musical score data D1 to generate acoustic features in a time period in which the musical score data D1 is arranged. With this, it is easy to add, to acoustic data of sound of a specific timbre captured via a microphone, new acoustic data of the same timbre, or partially correct the acoustic data while maintaining the timbre.

The training (basic training) of the score encoder 111, the acoustic encoder 121, and the acoustic decoder 133 may include training of the score encoder 111, the acoustic encoder 121, and the acoustic decoder 133 so that the first intermediate features (intermediate feature data MF1) generated by the score encoder 111 based on the musical score data D1_R for basic training, approximate the second intermediate features (intermediate feature data MF2) generated by the acoustic encoder 121 based on the acoustic data D2_R for basic training, and so that the acoustic features (acoustic feature data AFS) generated by the acoustic decoder 133 approximate the acoustic features acquired from the acoustic data D2_R for basic training. The acoustic decoder 133 can generate the acoustic feature data AFS with respect to both the intermediate feature data MF1 generated based on the musical score data D1 and the intermediate feature data MF2 generated based on the acoustic data D2.

Using plurality of pieces of acoustic data of the plurality of first sound sources (timbres), the acoustic decoder 133 may be trained (basic training) with respect to the first value identifier (sound source ID) identifying the first sound source corresponding to the acoustic data. Upon designation of the identifier of one of the first values, the acoustic decoder 133 subjected to the basic training generates synthesized sound of the timbre of the sound source specified by this value.

The acoustic decoder 133 that has been subjected to the basic training may be subjected to auxiliary training using a relatively small amount of acoustic data of a second sound source other than the first sound source with respect to an identifier of the second value (sound source ID) other than the first value. The acoustic decoder 133 that has additionally trained generates, upon designation of an identifier of the second value, synthesized sound of the timbre of the second sound source.

A sound synthesis program according to the present embodiment relates to a sound synthesis program that causes a computer to execute a sound synthesizing method, the program causing the computer to execute: processing of receiving musical score data (musical score data D1_S for synthesis) and acoustic data (acoustic data D2_S for synthesis) via a user interface 200; and processing of generating, based on the musical score data (musical score data D1_S for synthesis) and the acoustic data (acoustic data D2_S for synthesis), acoustic features (acoustic feature data AFS) of a sound waveform of a desired timbre. With this, it is possible to generate, based on the musical score data (musical score data D1_S for synthesis) and the acoustic data (acoustic data D2_S for synthesis) supplied from the user interface 200, acoustic data of the same timbre (sound quality), regardless of the type of data.

A sound conversion method according to one aspect (Aspect 1) of the present embodiment relates to a method that is realized by a computer, the method including the steps of: (1) preparing the score encoder 111 and the acoustic encoder 121 that are trained so that intermediate features generated by the score encoder 111 and the acoustic encoder 121 approximate each other, and the acoustic decoder 133 that is trained using sounds with a plurality of sound source IDs specifying sound sources of the sounds and including a specific sound source ID (e.g., ID(a)); receiving designation of the specific sound source ID; (3) acquiring sound at each time point via a microphone; (4) generating, from the acquired sound, acoustic feature data AF at the time point representing a frequency spectrum of the sound; (5) supplying the generated acoustic feature data AF to the acoustic encoder 121 subjected to basic training so as to generate intermediate feature data MF2 at the time point that corresponds to the sound; (6) supplying the designated sound source ID and the generated intermediate feature data MF2 to the acoustic decoder 133 to generate acoustic feature data AFS (e.g., acoustic feature data AFS(a)) at the time point; and (7) synthesizing, based on the generated acoustic feature data AFS, acoustic data D3 (e.g., synthesized acoustic data D3(a)) representing an acoustic signal having a timbre similar to the sound of the sound source specified by the designated sound source ID and outputting the synthesized acoustic data D3. The timbre conversion method can convert, for example, sound of an arbitrary sound source B captured via the microphone into sound of the sound source A in real time. In other words, the timbre conversion method can synthesize, from sound that was “sung or played by a singer B or a musical instrument B on a musical piece” and captured via the microphone, sound that corresponds to sound “sung or played by a singer A or a musical instrument A on the musical piece” in real time.

In a specific example (Aspect 2) of Aspect 1, the score encoder 111 and the acoustic encoder 121 may be subjected to training (basic training) so that, with respect to acoustic data D2R of sound sources including at least one sound source specified by a sound source ID, intermediate feature data MF1 output by the score encoder 111 in response to input of score feature data SF generated from the corresponding musical score data D1_R, and intermediate feature data MF2 output by the acoustic encoder 121 in response to input of acoustic feature data AF generated from the acoustic data D2_R, approximate each other.

In a specific example (Aspect 3) of Aspect 2, the acoustic decoder 133 may be subjected to training (basic training) so that, with respect to the acoustic data D2_R of the sound sources including the at least one sound source specified by the sound source ID, each of acoustic feature data AFS1 output by the acoustic decoder 133 in response to input of the intermediate feature data MF1, and acoustic feature data AFS2 output by the acoustic decoder 133 in response to input of the intermediate feature data MF2, approximate the acoustic feature data AF generated from the acoustic data D2_R.

In a specific example (Aspect 4) of Aspect 3, the sound sources of the acoustic data D2_R include the sound source specified by the specific sound source ID.

In a specific example (Aspect 5) of Aspect 3, the sound sources of the acoustic data D2_R don't include the sound source specified by the specific sound source ID, and the acoustic decoder 133 may further be subjected to training (auxiliary training) so that, with respect to acoustic data D2_T(a) of the sound source specified by the specific sound source ID, the acoustic feature data AFS2(a) output by the acoustic decoder 133 in response to input of the intermediate feature data MF2(a), which is output by the acoustic encoder 121 in response to input of acoustic feature data AF(a) generated from the acoustic data D2_T(a), approximates the acoustic feature data AF(a).

### REFERENCE SIGNS LIST

100 . . . Control unit, 110 . . . Conversion unit, 111 . . . Score encoder, 120 . . . Analysis unit, 121 . . . Acoustic encoder, 131 . . . Switching 20 unit, 133 . . . Acoustic decoder, 134 . . . Vocoder, D1 . . . Musical score data, D2 . . . Acoustic data, D3 . . . Synthesized acoustic data, SF . . . Score feature data, AF . . . Acoustic feature data, MF1, MF2 . . . Intermediate feature data, AFS . . . Acoustic feature data

1. A sound synthesizing method that is realized by a computer, comprising:
receiving musical score data and acoustic data via a user interface; and
generating, based on respective one of the musical score data and the acoustic data, acoustic features of a sound waveform having a desired timbre.

2. The sound synthesizing method according to claim 1,
wherein the musical score data and the acoustic data are data arranged in time periods along a time axis respectively, and
the method comprising:
processing the musical score data using a score encoder to generate first intermediate features;
processing the acoustic data using an acoustic encoder to generate second intermediate features; and
processing the first intermediate features and the second intermediate features using an acoustic decoder to generate the acoustic features respectively.

3. The sound synthesizing method according to claim 2,
wherein the score encoder is trained to generate the first intermediate features from score features of musical score data for training,
the acoustic encoder is trained to generate the second intermediate features from acoustic features of acoustic data for training, and
the acoustic decoder is trained to generate acoustic features close to acoustic features for training, based on the first intermediate features generated from the score features of the musical score data for training and based on the second intermediate features generated from the acoustic features of the acoustic data for training respectively.

4. The sound synthesizing method according to claim 3,
wherein the musical score data for training and the acoustic data for training have the same performance timing, performance intensity, and performance expression of individual notes each other, and
the score encoder, the acoustic encoder, and the acoustic decoder are subjected to basic training so that the first intermediate features generated by the score encoder and the second intermediate features generated by the acoustic encoder approximate each other.

5. The sound synthesizing method according to claim 2,
wherein the score encoder is configured to generate the first intermediate features from the musical score data in a first time period of musical sounds,
the acoustic encoder is configured to generate the second intermediate features from the acoustic data in a second time period of the musical sounds, and
the acoustic decoder is configured to generate the acoustic features in the first time period from the first intermediate features, and is configured to generate the acoustic features in the second time period from the second intermediate features.

6. The sound synthesizing method according to claim 2,
wherein the score encoder, the acoustic encoder, and the acoustic decoder are machine learning models trained using training data.

7. The sound synthesizing method according to claim 1,
wherein the musical score data and the acoustic data are arranged, by a user, on a user interface along a time axis and a pitch axis.

8. The sound synthesizing method according to claim 2,
wherein the acoustic decoder is configured to generate the acoustic features based on an identifier that specifies a sound source among a plurality of sound sources.

9. The sound synthesizing method according to claim 2, further comprising:
converting the acoustic features generated by the acoustic decoder into the sound waveform.

10. The sound synthesizing method according to claim 2,
wherein the first intermediate features and the second intermediate features are coupled to each other along a time axis, and the coupled intermediate features are input to the acoustic decoder.

11. The sound synthesizing method according to claim 5,
wherein the acoustic features in the first time period and the acoustic features in the second time period are coupled to each other along a time axis, and the synthesized acoustic data is generated from the coupled acoustic features.

12. The sound synthesizing method according to claim 5,
wherein the synthesized acoustic data generated from the acoustic features in the first time period, and the synthesized acoustic data generated from the acoustic features in the second time period are coupled to each other along a time axis.

13. The sound synthesizing method according to claim 2,
wherein the score encoder is configured to process, at each time point, context out of at least one of phoneme, note pitch, and note intensity of a musical piece defined by the musical score data, to generate the first intermediate features.

14. The sound synthesizing method according to claim 2,
wherein the acoustic encoder is configured to process, at each time point, acoustic feature data representing a frequency spectrum of a sound waveform represented by the acoustic data, to generate the second intermediate features.

15. The sound synthesizing method according to claim 3,
wherein the acoustic data is acoustic data for auxiliary training, and
the method further comprises subjecting the acoustic decoder to auxiliary training using the second intermediate features generated by the acoustic encoder from acoustic features of the acoustic data for auxiliary training, and the acoustic features of the acoustic data for auxiliary training, the acoustic decoder being auxiliary trained to generate acoustic features close to the acoustic features of the acoustic data for auxiliary training, and
wherein the musical score data is arranged in a time period along a time axis of the acoustic data for auxiliary training, and
the method further comprises processing, using the acoustic decoder after the auxiliary training, the first intermediate features generated by the score encoder from the arranged musical score data to generate acoustic features in the time period in which the musical score data is arranged.

16. The sound synthesizing method according to claim 15,
wherein the training of the score encoder, the acoustic encoder, and the acoustic decoder includes
training of the score encoder, the acoustic encoder, and the acoustic decoder so that the first intermediate features generated by the score encoder based on musical score data for basic training and the second intermediate features generated by the acoustic encoder based on acoustic data for basic training approximate each other, and so that the acoustic decoder generates the acoustic features close to acoustic features of the acoustic data for basic training.

17. The sound synthesizing method according to claim 15,
wherein the acoustic encoder is trained, using acoustic features of acoustic data for basic training generated by a first sound source specified by an identifier having a first value, with the identifier having the first value.

18. The sound synthesizing method according to claim 17,
wherein the acoustic data for auxiliary training represents sound generated by a second sound source specified by an identifier having a second value different from the first value, and the auxiliary training on the acoustic decoder using the acoustic data for auxiliary training is performed with the identifier having the second value.

19. The sound synthesizing method according to claim 15,
wherein the score features indicate, of a musical piece defined by the musical score data, context of at least one of phoneme, note pitch, and note intensity at each time point.

20. The sound synthesizing method according to claim 15,
wherein the acoustic features represent a frequency spectrum, at each time point, of a sound waveform indicated by the acoustic data.

21. A non-transitory computer readable medium storing a program executable by a computer to execute a sound synthesizing method comprising:
processing of receiving musical score data and acoustic data via a user interface; and
processing of generating, based on respective one of the musical score data and the acoustic data, acoustic features of a sound waveform of a desired timbre.
